(19) United States
(12) Patent Application Publication
(10) Pub. No.: US 2020/0036932 A1
(43) Pub. Date: Jan. 30, 2020

(54) METHOD AND SYSTEM FOR REMOTE CONTROL OF SWITCHER

(71) Applicants: HKC CORPORATION LIMITED, SHUITIAN VILLAGE, SHIYAN SUB (CN); CHONGQING HKC OPTOELECTRONICS TECHNOLOGY CO., LTD., CHONGQING (CN)

(72) Inventor: PO-SUNG PAN, CHONGQING (CN)

(21) Appl. No.: 16/491,364

(22) PCT Filed: Aug. 31, 2017
(86) PCT No.: PCT/CN2017/099883

§ 371 Date: Sep. 5, 2019

(30) Foreign Application Priority Data
Apr. 11, 2017 (CN) 201710233862.2

(51) Int. Cl. H04N 5/44; H04N 5/268; H04N 7/18; G06F 3/023

(52) U.S. Cl. CPC H04N 5/4403; H04N 5/268; H04N 7/18; H04N 2005/4432; H04N 2005/4416; H04N 2005/4426; G06F 3/023

(57) ABSTRACT

A switch remote control method is provided. The method is used for a remote control system of a KVM (Keyboard Video Mouse) matrix switch. The KVM matrix switch is connected with a plurality of switch transmitting devices and a plurality of switch receiving devices. The method includes the steps of: receiving data of the plurality of switch transmitting devices by the KVM matrix switch; transmitting the received data to at least one of the switch receiving devices according to preset allocation information by the KVM matrix switch; adjusting the allocation information according to a reallocation command and transmitting the data to the corresponding switch receiving devices by the KVM matrix switch.

### FIELD OF THE INVENTION

This application is a National Stage Application of PCT International Patent Application No. PCT/CN2017/099883 filed on Aug. 31, 2017, under 35 U.S.C. §371, which claims priority to and the benefit of Chinese Patent Application No. 2017102338622, filed on Apr. 11, 2017, and the disclosure of which is incorporated herein in its entirety by reference.

The present invention relates to the remote control technology, and more particularly to a switch remote control method and a system.

### BACKGROUND OF THE INVENTION

In the traditional technology, in order to achieve an unmanned factory, a KVM (Keyboard Video Mouse) switch is used to transmit the pictures of the equipment in the factory to a central control room. By a remote control device (keyboard/mouse/display), the pictures of the equipment are monitored to achieve the control. The transmission of the pictures of the equipment, especially the pictures of detecting machines, requires no loss of picture quality and no delay to transmit to the operator for interpretation, so that the interpretation for the running of the equipment is more accurate to achieve a good control effect.

However, the traditional method uses one-to-many KVM switch, that is, a person detects and controls the pictures of a plurality of devices. The same seat can only operate independently, and there is no communication between persons. When a person is absent because of leaving or taking a break, the other persons cannot complete the task of the absent person through a switch control. As a result, the relevant persons can only complete the task independently and cannot work together. The working efficiency is not high.

### SUMMARY OF THE INVENTION

The primary object of the present invention is to provide a switch remote control method and a system to overcome the problem that the relevant persons can only complete the task independently and cannot work together and that the working efficiency is not high.

According to one aspect of the present invention, a switch remote control method is provided. The method is used for a remote control system of a KVM (Keyboard Video Mouse) matrix switch. Wherein, the KVM matrix switch is connected with a plurality of switch transmitting devices and a plurality of switch receiving devices. The method includes the steps of: the KVM matrix switch receiving data of the plurality of switch transmitting devices; the KVM matrix switch transmitting the received data to at least one of the switch receiving devices according to preset allocation information; the KVM matrix switch adjusting the allocation information according to a reallocation command and transmitting the data to the corresponding switch receiving device.

According to another aspect of the present invention, a switch remote control system is provided. The system is used to execute the aforesaid switch remote control method. The system includes: a plurality of switch transmitting devices, configured to acquire information about operating devices running in a factory and transmit the information; a plurality of switch receiving devices, configured to receive the information acquired by the plurality of switch transmitting devices; a KVM (Keyboard Video Mouse) matrix switch, configured to receive data transmitted by the plurality of switch transmitting devices and transmit the received data to at least one of the switch receiving devices according to preset allocation information and adjust the allocation information according to a reallocation command and transmit the data to at least one of the switch receiving devices.

According to a further aspect of the present invention, a switch remote control method is provided. The method is used for a remote control system of a KVM (Keyboard Video Mouse) matrix switch. Wherein, the KVM matrix switch is connected with a plurality of switch transmitting devices and a plurality of switch receiving devices. The method includes the steps of: the KVM matrix switch detecting whether or not the switch transmitting device or the switch receiving device is accessed; when the KVM matrix switch detects that the switch transmitting device or the switch receiving device is accessed, the KVM matrix switch allocating a unique identifier to the switch transmitting device or the switch receiving device; the KVM matrix switch storing allocation information and receiving and transmitting data according to the unique identifier; the KVM matrix switch receiving data of the plurality of switch transmitting devices; the KVM matrix switch transmitting the received data to at least one of the switch receiving devices according to the preset allocation information; when it is detected that one of the switch receiving devices stops receiving data, a reallocation command being automatically generated; the received data being reallocated to the other switch receiving devices; the KVM matrix switch detecting whether or not the switch receiving device that stops receiving data has a request for receiving data, if yes, the KVM matrix switch adjusting the allocation information and transmitting corresponding data to the switch receiving device.

According to a yet further aspect of the present invention, a switch remote control system is provided. The system includes: a plurality of switch transmitting devices, configured to acquire information about operating devices running in a factory and transmit the information; a plurality of switch receiving devices, configured to receive the information acquired by the plurality of switch transmitting devices; a KVM (Keyboard Video Mouse) matrix switch. The KVM matrix switch is configured to detect whether or not the switch transmitting device or the switch receiving device is accessed. When the KVM matrix switch detects that the switch transmitting device or the switch receiving device is accessed, the KVM matrix switch allocates a unique identifier to the switch transmitting device or the switch receiving device. The KVM matrix switch stores allocation information and receives and transmits data according to the unique identifier. The KVM matrix switch receives data of the plurality of switch transmitting devices. The KVM matrix switch transmits the received data to at least one of the switch receiving devices according to the preset allocation information. When it is detected that one of the switch receiving devices stops receiving data, a reallocation command is automatically generated. The received data is reallocated to the other switch receiving devices. The KVM matrix switch detects whether or not the switch receiving device that stops receiving data has a request for receiving data, if yes, the KVM matrix switch adjusts the allocation information and transmits corresponding data to the switch receiving device.

The above-mentioned switch remote control method and the system achieve mutual backup between the staff through the KVM matrix switch. When one of the staff leaves the seat, the device to be detected will be allocated by the KVM matrix switch to other operators, so that the monitoring of the pictures of the equipment in the factory is not affected by the absent person. Any person can receive the pictures of all the equipment connected to the KVM matrix switch for detection and control. In the prior art, persons complete the task independently and cannot work together. The present invention improves the efficiency and co-operation ability of the staff

### BRIEF DESCRIPTION OF THE DRAWINGS

In order to clearly illustrate the embodiments of the present invention or the technical solutions in the existing technology, the following drawings, which are used in the description, are briefly described. The accompanying drawings in the following description are merely illustrative embodiments of the present invention. For those skilled in the art, the drawings of other embodiments may be obtained according to the accompanying drawings under the premise of not paying creative work.

FIG. 1 is a flow chart of a switch remote control method in accordance with an embodiment of the present invention;

FIG. 2 is a flow chart of a switch remote control method in accordance with another embodiment of the present invention;

FIG. 3 is a flow chart of a switch remote control method in accordance with a further embodiment of the present invention;

FIG. 4 is a flow chart of a switch remote control method in accordance with a yet further embodiment of the present invention;

FIG. 5 is a schematic view of a switch remote control system in accordance with an embodiment of the present invention; and

FIG. 6 is a schematic view of the interface adaptive technology of a KVM matrix switch in accordance with an embodiment of the present invention.

### DESCRIPTION OF THE PREFERRED EMBODIMENTS

Embodiments of the present invention will now be described, by way of example only, with reference to the accompanying drawings.

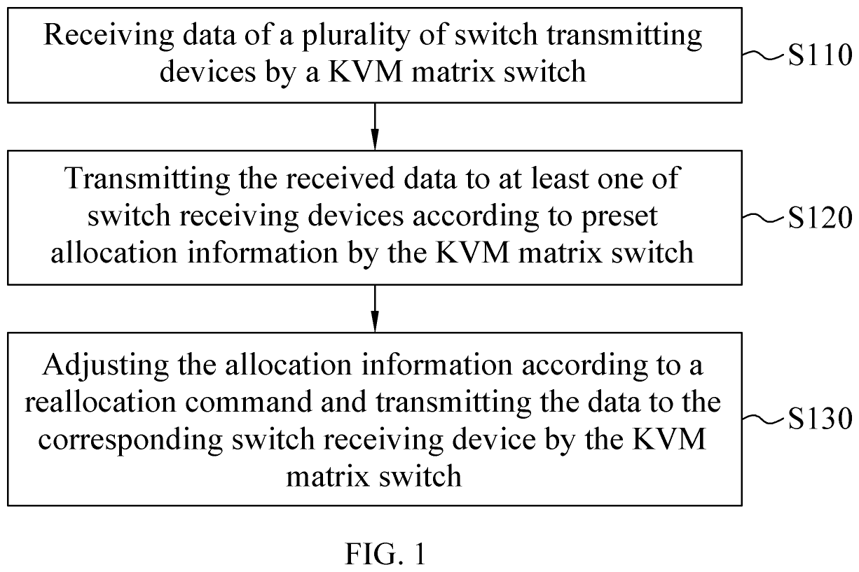

FIG. 1 is a flow chart of a switch remote control method in accordance with an embodiment of the present invention. In this embodiment, the switch remote control method includes the following steps:

Step S110: a KVM (keyboard Video Mouse) matrix switch receives data of a plurality of switch transmitting devices.

Wherein, an optical fiber KVM matrix switch is an extendable/hardware dual backup optical fiber switch, which can communicate with signals of different ports (similar to a network switch). The optical fiber KVM matrix switch may receive the data transmitted by the plurality of switch transmitting devices.

Step S120: The KVM matrix switch transmits the received data to at least one switch receiving device according to the preset allocation information.

Wherein, the optical fiber KVM matrix switch is connected with a plurality of switch transmitting devices and a plurality of switch receiving devices based on a remote control system including a KVM matrix switch. When receiving the data from the plurality of switch transmitting devices, the optical fiber KVM matrix switch may allocate the received data according to the preset allocation information to the plurality of switch receiving devices. The preset allocation information can be set and modified according to whether or not the person is on duty and the person's ability. The data transmitted by one of the switch transmitting devices may be allocated to the plurality of switch receiving devices so that the plurality of switch receiving devices can acquire the same data simultaneously, which facilitates the cooperation of the persons to complete the same task.

Step S130: The KVM matrix switch may adjust the allocation information according to a reallocation command and transmit the data to the corresponding switch receiving device.

Wherein, after the data is allocated in accordance with the preset allocation information, if a person takes a break, asks for leave, or leaves the seat, the switch receiving device that the person is in charge cannot process the received data. At this time, the person or manager may send the information of leaving to the optical fiber KVM matrix switch to regenerate the corresponding allocation scheme to transmit the data received by the switch receiving device to the other switch receiving devices. This ensures that when there is a change in personnel, the system is still able to run normally, not affected.

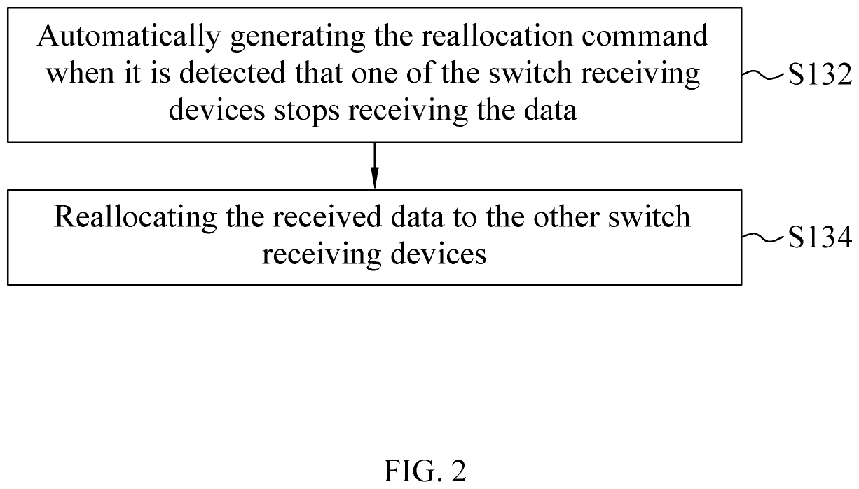

As shown in FIG. 2, in an embodiment, the step S130 includes:

Step S132: The reallocation command is automatically generated when it is detected that one of the switch receiving devices stops receiving data.

Step S134: The received data is reallocated to the other switch receiving devices.

Wherein, when a person takes a break, asks for leave, or leaves the seat, the switch receiving device that the person is in charge cannot work normally. At this time, the person or manager may send a command to stop receiving data to the optical fiber KVM matrix switch. When the command is detected by the optical fiber KVM matrix switch, the optical fiber KVM matrix switch immediately takes an appropriate action, that is, automatically generates the reallocation command. Meanwhile, according to the reallocation command, the received data is reallocated to the other switch receiving devices to ensure the normal operation of the system. In other embodiments, the reallocation command may be generated according to the user's operations.

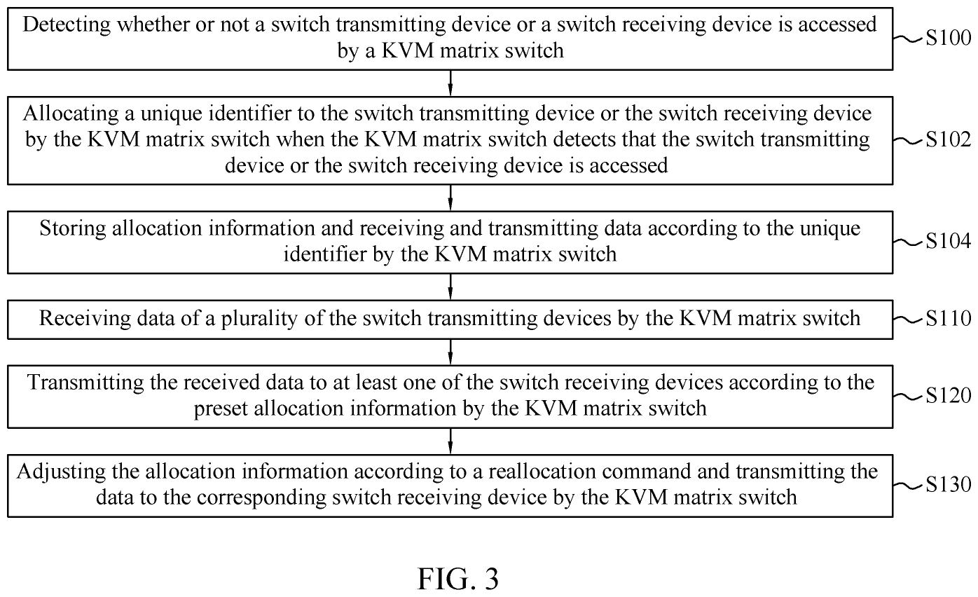

FIG. 3 is a flow chart of a switch remote control method in accordance with another embodiment of the present invention. On the basis of the embodiment shown in FIG. 1, the switch remote control method further includes the following steps before the step S110:

Step S100: The KVM matrix switch detects whether or not a switch transmitting device or a switch receiving device is accessed.

Step S102: When the KVM matrix switch detects the switch transmitting device or the switch receiving device is accessed, the KVM matrix switch allocates a unique identifier to the switch transmitting device or the switch receiving device.

Step S104: The KVM matrix switch stores the allocation information and receives and transmits data according to the unique identifier.

Wherein, when the remote control system including the KVM matrix switch detects that a new switch transmitting device or a new switch receiving device is accessed, the optical fiber KVM matrix switch detects the access device and allocates a unique identifier to the access device, meanwhile, the optical fiber KVM matrix switch stores the allocation information for the adjustment of the allocation information. The unique identifier is used for the reception and transmission of the data to ensure the accuracy of the system data transmission.

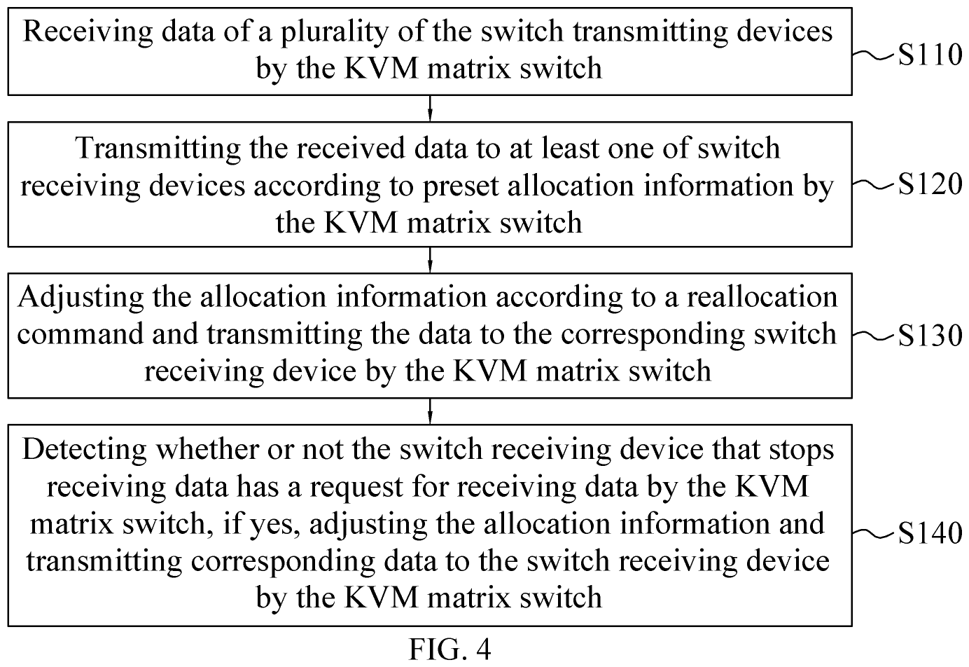

FIG. 4 is a flow chart of a switch remote control method in accordance with a further embodiment of the present invention. On the basis of the embodiment shown in FIG. 1, the switch remote control method further includes the following steps after the step S130:

Step S140: The KVM matrix switch detects whether or not the switch receiving device that stops receiving data has a request for receiving data, if yes, the KVM matrix switch adjusts the allocation information and transmits the corresponding data to the switch receiving device.

Wherein, the optical fiber KVM matrix switch adjusts the allocation information based on the departure of personnel to ensure the normal operation of the system. When the corresponding person returns to work, the relevant command to receive data again can be sent to the optical fiber KVM matrix switch. When the optical fiber KVM matrix switch receives the command, it will adjust the allocation information again. The corresponding data resends to the switch receiving devices, so that the system returns to the initial working state.

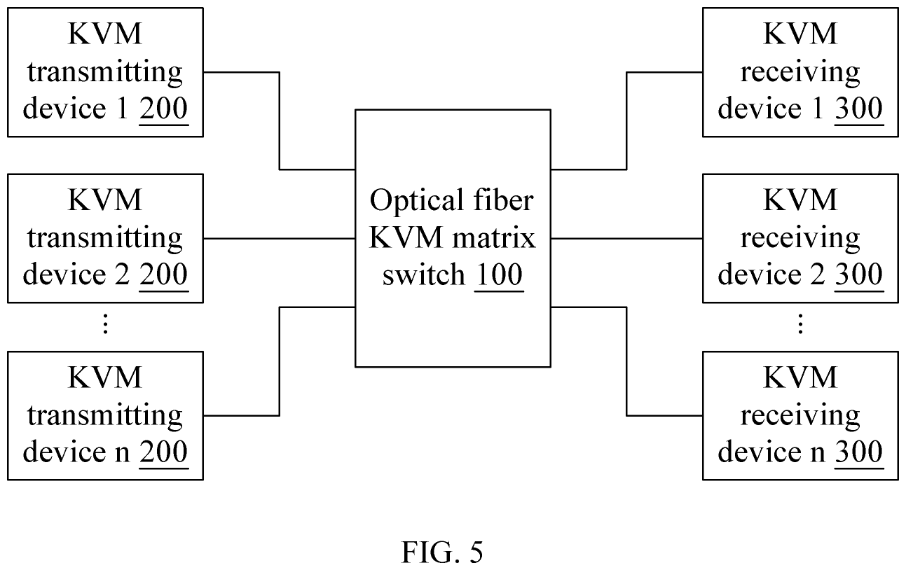

FIG. 5 is a schematic view of a switch remote control system in accordance with an embodiment of the present invention. A switch remote control system 10 of this embodiment includes an optical fiber KVM matrix switch 100, a plurality of KVM transmitting devices 200, and a plurality of KVM receiving devices 300.

The optical fiber KVM matrix switch 100 is configured to receive the data transmitted by the plurality of KVM transmitting devices 200 and transmit the received data to at least one of the KVM receiving devices 300 according to the preset allocation information and adjust the allocation information according to a reallocation command and transmit the data to at least one of the KVM receiving devices 300. Wherein, the optical fiber KVM matrix switch 100 allocates the received data according to the allocation information. Normally, the optical fiber KVM matrix switch 100 transmits the data according to the preset allocation information, and adjusts the allocation when there is a person absent or the allocation information is changed. According to the adjusted allocation information, the optical fiber KVM matrix switch 100 transmits and allocates the data.

In an embodiment, the optical fiber KVM matrix switch 100 is further configured to detect whether or not a KVM transmitting device 200 or a KVM receiving device 300 is accessed.

When it is detected that the KVM transmitting device 200 or the KVM receiving device 300 is accessed, the optical fiber KVM matrix switch 100 allocates a unique identifier to the KVM transmitting device 200 or the KVM receiving device 300, stores the allocation information, and receives and transmits the data according to the unique identifier. Wherein, the allocation of the unique identifier is beneficial for the management of the system. The system can receive and transmit the data based on the unique identifier. Each KVM transmitting device or each KVM receiving device has a unique identifier, greatly reducing the possibility of system data transmission errors.

The plurality of KVM transmitting devices 200 are configured to acquire information about the operating devices running in the factory and transmit the information to the optical fiber KVM matrix switch 100. In order to achieve the unmanned factory, the operation of the equipment in the factory requires the monitoring equipment to transmit the pictures of machines to a central control room. Since the transmission of the pictures requires no loss of picture quality and no delay to be transmitted to the operator. Therefore, the above-described requirement can be achieved by using the optical fiber KVM transmitting devices 200 very well.

The plurality of KVM receiving devices 300 are configured to receive the information acquired by the plurality of KVM transmitting devices 200. Wherein, the KVM receiving devices 300 are configured to receive the data, such as the pictures of machines transmitted from the KVM transmitting devices 200, and display the data to a corresponding operator.

In an embodiment, the operator may be unable to continue the task because of asking for leaving, taking a break, leaving the seat etc. At this time, the plurality of KVM receiving devices 300 are configured to transmit a request to stop receiving data to the optical fiber KVM matrix switch 100 according to the management operating commands. The optical fiber KVM matrix switch 100 responds to the request to stop receiving data and adjusts the allocation information and transmits the data to the other KVM receiving devices 300 according to the adjusted result, so that the system can operate normally without being affected by the person's departure. Meanwhile, the optical fiber KVM matrix switch is further configured to detect whether the KVM receiving device 300 that stops receiving the data has a request to receive data, if yes, the optical fiber KVM matrix switch adjusts the allocation information and transmits the corresponding data to the KVM receiving device 300. After the person returns to the seat, the optical fiber KVM matrix switch readjusts the allocation information to be in the initial allocation state, so that the system returns to the initial working state to continue running.

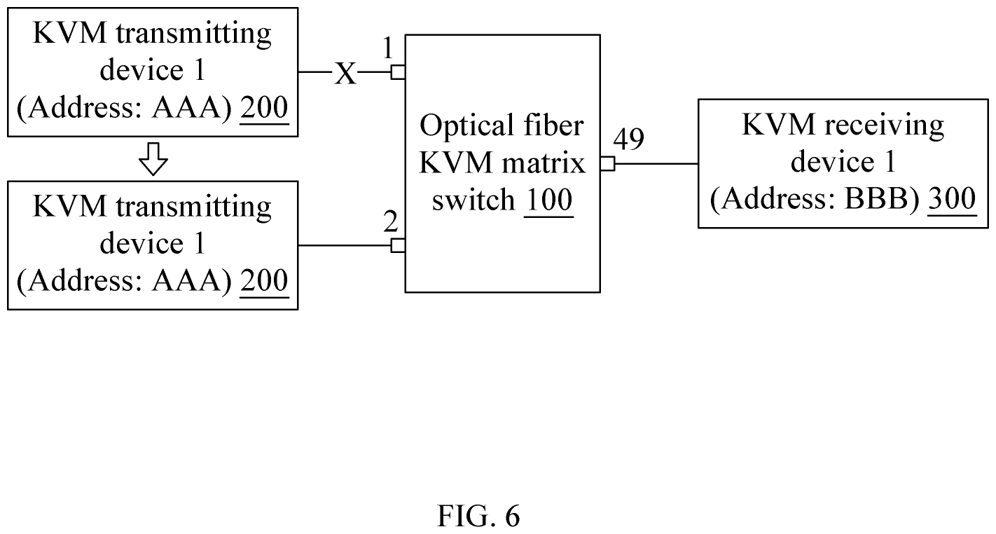

FIG. 6 is a schematic view of the interface adaptive technology of the optical fiber KVM matrix switch. The interface adaptive technology can achieve a data transmission cable to be plugged to another spare port. The system achieves automatic addressing recognition and rapid signal recovery. If a port fails during data transmission, the data can be quickly restored by changing the port. The implementation of the interface adaptive technology is as follows:

Each KVM transmitting device 200 has a fixed transmitting address AAA, and each KVM receiving device 300 has a fixed receiving address BBB;

The KVM transmitting device 200 is connected to the port 1 of the KVM matrix switch 100, and the KVM receiving device 300 is connected to the port 49 of the KVM matrix switch to realize data transmission;

When the data transmission of the port 1 is interrupted, the KVM transmitting device 200 is connected to the port 2 of the KVM matrix switch 100, and the transmitting address of the KVM transmitting device 200 is still AAA, and the KVM matrix switch 100 automatically connects the interrupted connection according to the address.

The above-mentioned switch remote control method and system achieve mutual backup between the staff through the optical fiber KVM matrix switch. When one of the staff leaves the seat, the device to be detected will be allocated by the optical fiber KVM matrix switch to other operators, so that the monitoring of the pictures of the equipment in the factory is not affected by the absent person. Any person can receive the pictures of all the equipment connected to the optical fiber KVM matrix switch for detection and control. In the prior art, persons complete the task independently and cannot work together. The present invention improves the efficiency and co-operation ability of the staff.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A switch remote control method of a remote control system of a KVM (Keyboard Video Mouse) matrix switch, wherein the KVM matrix switch is connected to a plurality of switch transmitting devices and a plurality of switch receiving devices, and the method comprises steps of:
receiving data of the plurality of switch transmitting devices by the KVM matrix switch;
transmitting the received data to at least one of the switch receiving devices according to preset allocation information by the KVM matrix switch; and
adjusting the allocation information according to a reallocation command and transmitting the data to the corresponding switch receiving device by the KVM matrix switch.

2. The method as claimed in claim 1, wherein the step of adjusting the allocation information according to the reallocation command and transmitting the data to the corresponding switch receiving device by the KVM matrix switch comprises:
automatically generating the reallocation command when it is detected that one of the switch receiving devices stops receiving the data; and
reallocating the received data to the other switch receiving devices.

3. The method as claimed in claim 1, wherein the step of adjusting the allocation information according to the reallocation command and transmitting the data to the corresponding switch receiving device by the KVM matrix switch comprises:
generating the reallocation command according to a user's operation; and
reallocating the received data to the switch receiving devices.

4. The method as claimed in claim 3, wherein the user operation comprises sending a request to stop receiving data and sending a request for receiving data.

5. The method as claimed in claim 1, before the step of receiving the data of the plurality of switch transmitting devices by the KVM matrix switch, further comprising:
detecting whether or not the switch transmitting device or the switch receiving device is accessed by the KVM matrix switch;
allocating a unique identifier to the switch transmitting device or the switch receiving device by the KVM matrix switch when the KVM matrix switch detects that the switch transmitting device or the switch receiving device is accessed; and
storing the allocation information and receiving and transmitting data according to the unique identifier by the KVM matrix switch.

6. The method as claimed in claim 1, after the step of adjusting the allocation information and transmitting the data to the other switch receiving devices by the KVM matrix switch, further comprising:
detecting whether or not the switch receiving device that stops receiving data has a request for receiving data by the KVM matrix switch, if yes, adjusting the allocation information and transmitting corresponding data to the switch receiving device by the KVM matrix switch.

7. The method as claimed in claim 1, wherein the switch transmitting devices each have a fixed transmitting address, the switch receiving devices each have a fixed receiving address, and communication between the switch transmitting devices and the switch receiving devices is automatically matched by the KVM matrix switch according to the transmitting and receiving addresses.

8. The method as claimed in claim 1, wherein the data transmitted by one of the switch transmitting devices is simultaneously allocated to the plurality of switch receiving devices.

9. The method as claimed in claim 1, wherein the KVM matrix switch adopts an interface adaptive means to recover data transmission after a port is switched.

10. A switch remote control system, comprising:
a plurality of switch transmitting devices, configured to acquire information about operating devices running in a factory and transmit the information;
a plurality of switch receiving devices, configured to receive the information acquired by the plurality of switch transmitting devices; and
a KVM (Keyboard Video Mouse) matrix switch, configured to receive data transmitted by the plurality of switch transmitting devices and transmit the received data to at least one of the switch receiving devices according to preset allocation information and adjust the allocation information according to a reallocation command and transmit the data to at least one of the switch receiving devices.

11. The system as claimed in claim 10, wherein the KVM matrix switch is configured to detect whether or not the switch transmitting device or the switch receiving device is accessed, when it is detected that the switch transmitting device or the switch receiving device is accessed, the KVM matrix switch allocates a unique identifier to the switch transmitting device or the switch receiving device, stores the allocation information, and receives and transmits the data according to the unique identifier.

12. The system as claimed in claim 10, wherein the plurality of switch receiving devices are configured to transmit a request to stop receiving data to the KVM matrix switch according to management operating commands.

13. The system as claimed in claim 12, wherein the KVM matrix switch is configured to detect whether or not the switch receiving devices have a request to stop receiving data, if yes, the KVM matrix switch adjusts the allocation information and transmits corresponding data to the switch receiving device.

14. The system as claimed in claim 10, wherein the plurality of switch receiving devices are configured to transmit a request to receive data to the KVM matrix switch according to management operating commands.

15. The system as claimed in claim 14, wherein the KVM matrix switch is configured to detect whether or not the switch receiving device that stops receiving data has a request to receive data, if yes, the KVM matrix switch adjusts the allocation information and transmits corresponding data to the switch receiving device.

16. The system as claimed in claim 10, wherein the switch transmitting devices each have a fixed transmitting address, the switch receiving devices each have a fixed receiving address, and communication between the switch transmitting devices and the switch receiving devices is automatically matched by the KVM matrix switch according to the transmitting and receiving addresses.

17. The system as claimed in claim 10, wherein the KVM matrix switch is configured to control the data transmitted by one of the switch transmitting devices to be simultaneously allocated to the plurality of switch receiving devices.

18. The system as claimed in claim 10, wherein the KVM matrix switch adopts an interface adaptive means to recover data transmission after a port is switched.

19. A switch remote control method of a remote control system of a KVM (Keyboard Video Mouse) matrix switch, wherein the KVM matrix switch is connected with a plurality of switch transmitting devices and a plurality of switch receiving devices, the method comprising steps of:
detecting whether or not the switch transmitting device or the switch receiving device is accessed by the KVM matrix switch;
allocating a unique identifier to the switch transmitting device or the switch receiving device by the KVM matrix switch when the KVM matrix switch detects that the switch transmitting device or the switch receiving device is accessed;
storing allocation information and receiving and transmitting data according to the unique identifier by the KVM matrix switch;
receiving data of the plurality of switch transmitting devices by the KVM matrix switch;
transmitting the received data to at least one of the switch receiving devices according to the preset allocation information by the KVM matrix switch;
automatically generating a reallocation command when it is detected that one of the switch receiving devices stops receiving data ;
reallocating the received data to the other switch receiving devices; and
detecting whether or not the switch receiving device that stops receiving data has a request for receiving data by the KVM matrix switch, if yes, adjusting the allocation information and transmitting corresponding data to the switch receiving device by the KVM matrix switch.
